(19) United States
(12) Patent Application Publication
(10) Pub. No.: US 2015/0094946 A1
(43) Pub. Date: Apr. 2, 2015

(54) LIGHT INDICATING DEVICE, POSITIONING DEVICE AND POSITIONING METHOD

(71) Applicant: HON HAI PRECISION INDUSTRY CO., LTD., New Taipei (TW)

(72) Inventor: CHIH-CHEN LAI, New Taipei (TW)

(21) Appl. No.: 14/495,062

(22) Filed: Sep. 24, 2014

(30) Foreign Application Priority Data
Sep. 30, 2013 (TW) 102135383

(51) Int. Cl. G01C 21/20; H05B 33/08

(52) U.S. Cl. CPC G01C 21/206; H05B 33/0842
USPC 701/409; 315/294; 701/408

(57) ABSTRACT

A light indicating device includes a plurality of light sources located in at least two positions, and at least one driving unit configured for driving the light sources to flash. Light sources at a same position flash at a same frequency, and light sources at different positions flash at different frequencies. A positioning device and method are also provided.

### FIELD

The present disclosure relates to a light indicating device, a positioning device and a positioning method.

### BACKGROUND

A navigation system of a car usually uses global positioning system (GPS) for positioning the car.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is an isometric view of a vehicle positioning system according to an exemplary embodiment of the present disclosure.

FIG. 2 is a diagrammatic view of a navigation unit.

FIG. 3 is a block diagram of the navigation unit of FIG. 2.

FIG. 4 is a flow chart of a positioning method.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “outside” refers to a region that is beyond the outermost confines of a physical object. The term “inside” indicates that at least a portion of a region is partially contained within a boundary formed by the object. The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “comprising,” when utilized, means “including, but not necessarily limited to”; it specifically indicates open-ended inclusion or membership in the so-described combination, group, series and the like.

The present disclosure is described in relation to a vehicle positioning system.

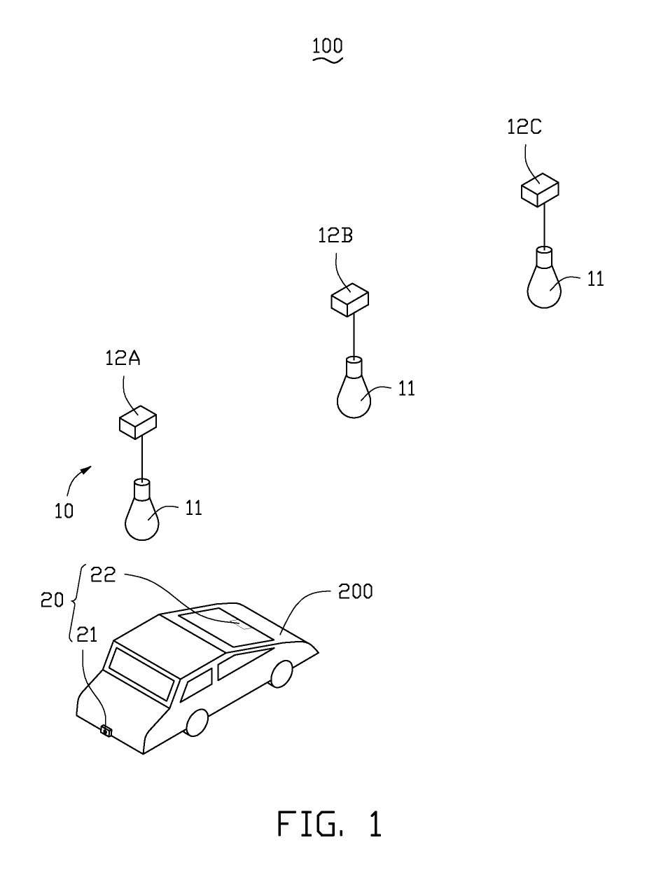

FIG. 1 shows a vehicle positioning system 100. The vehicle positioning system 100 is configured for positioning a car 200 in an indoor parking lot, and includes a light indicating device 10 mounted in the parking lot, and a positioning device 20 mounted in the car 200.

The light indicating device 10 lights the parking lot and sends out positioning signals. In detail, the light indicating device 10 includes a plurality of light sources 11 and a plurality of driving units 12A, 12B, and 12C. The driving units 12A, 12B, and 12C flash the light sources 11 at different frequencies. The flash frequencies are so high that the human eye cannot observe that the light sources 11 are flashing. In this embodiment, the flash frequencies are faster than 60 Hz.

In this embodiment, there are three light sources 11, a first driving unit 12A drives one of the light sources 11 to flash at a first frequency, a second driving unit 12B drives another of the light sources 11 to flash at a second frequency, a third driving unit 12C drives the other of the light sources 11 to flash at a third frequency. The light sources 11 are light emitting diodes (LEDs). The first frequency is 60 Hz, the second frequency is 70 Hz, and the third frequency is 80 Hz. The light sources 11 have different frequencies and are located at different areas of the parking lot, the light source 11 having the first frequency is located at a first area, the light source 11 having the second frequency is located at a second area, and the light source 11 having the third frequency is located at the third area.

In other embodiments, the light indicating device 10 includes only one driving unit for flashing the light sources 11 at different frequencies.

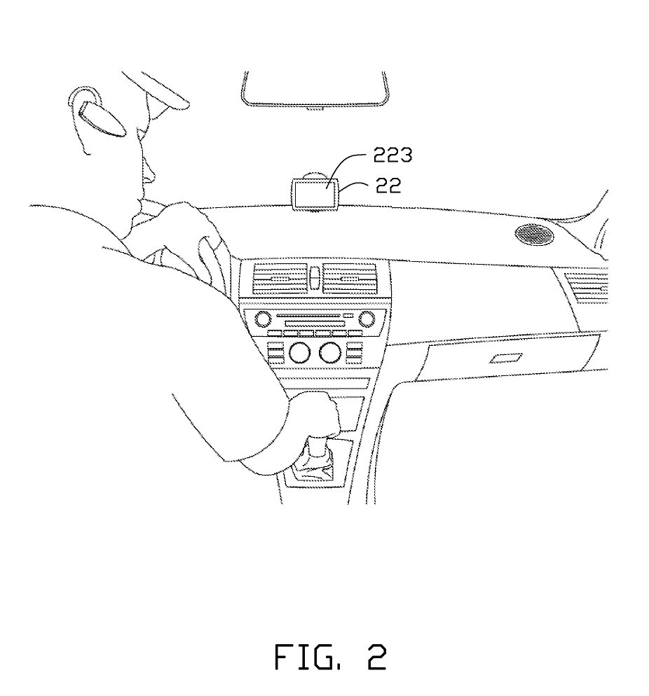

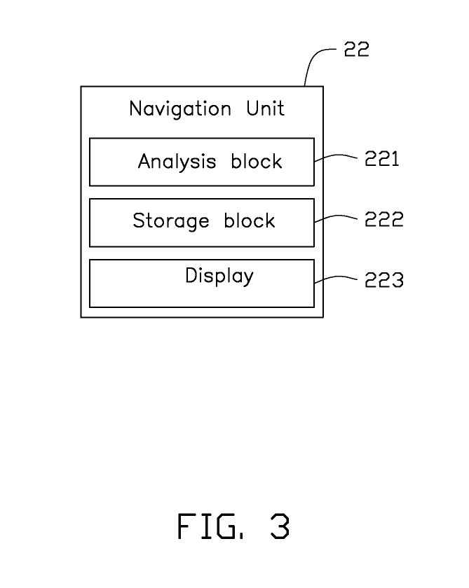

FIGS. 1-3 show the positioning device 20. The positioning device 20 includes a receiving unit 21 and a navigation unit 22.

In this embodiment, the receiving unit 21 is a photoelectric sensing module which receives light signals emitted from the light sources 11 and converts the light signals into electric signals. In other embodiments, the receiving unit 21 can also be a camera.

The navigation unit 22 is mounted above a console of the car 200. The navigation unit 22 is electrically connected to the receiving unit 21. The navigation unit 22 includes an analysis block 221, a storage block 222 and a display 223.

The analysis block 221 is configured for receiving electric signals from the receiving unit 21 and analyzes the flashing frequency of the corresponding light sources 11. In this embodiment, the analysis block 221 is a central processing unit (CPU).

The storage block 222 stores location information and flashing frequencies of all the light sources 11, and stores relationships between the location information and the flashing frequencies. In this embodiment, the storage block 222 is an electrically erasable memory.

The display 223 is a touch display, and is configured for displaying a map of the parking lot and a position of the car 200 in the parking lot.

When in use, the receiving unit 21 receives a light signal emitted from one of the light sources 11 adjacent to the car 200, converts the light signal into an electric signal, and sends the electric signal to the analysis block 221. The analysis block 221 analyzes the electric signal to obtain a current flashing frequency of the corresponding light source 11, compares the current flashing frequency with the flashing frequencies stored in the storage block 222, and obtains the current position of the car 200.

When the receiving unit 21 receives at least two light signals having different flashing signals, the receiving unit 21 converts the at least two light signals into at least two electric signals, the analysis block 221 selects a strongest one of the electric signals from the at least two electric signals and analyzes the strongest electric signal.

For example, the analysis block 221 includes bandpass filters that filter the signals from the receiving unit 21. The bandpass filters can be analog filters or digital filters. The digital filters could use a Fast Fourier Transform of the electrical signal. For the example of the three light sources flashing at 60 Hz, 70 Hz, and 80 Hz, respectively, a first bandpass filter is tuned to 60 Hz for producing a first electrical signal, a second bandpass filter is tuned to 70 Hz for producing a second electrical signal, and a third bandbass filter is tuned to 80 Hz for producing a third electrical signal. If the first electrical signal is the strongest one of the three electrical signals, then the analysis concludes that the car is located in the first area of the parking lot. If the second electrical signal is the strongest one of the three electrical signals, then the analysis concludes that the car is located in the second area of the parking lot. If the third electrical signal is the strongest one of the three electrical signals, then the analysis concludes that the car is located in the third area of the parking lot. In this example, the storage block 222 could store a table of three indications of position. The first indication would indicate the position of the first area of the parking lot. The second indication would indicate the position of the second area of the parking lot. The third indication would indicate the position of the third area of the parking lot.

The display 223 displays the current position of the car 200.

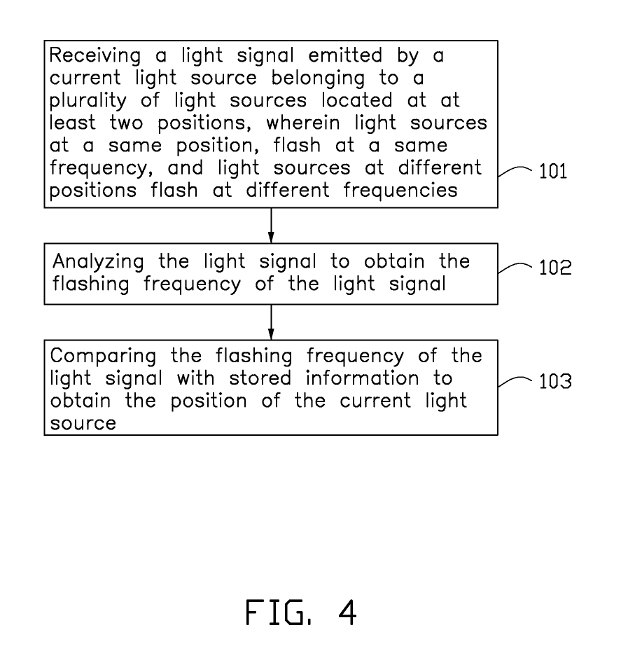

Referring to FIG. 4, a flowchart is presented in accordance with an example embodiment which is being thus illustrated. The example method is provided by way of example, as there are a variety of ways to carry out the method. The method described below can be carried out using the configurations illustrated in FIGS. 1 to 3, for example, and various elements of these figures are referenced in explaining example method. Each block shown in FIG. 4 represents one or more processes, methods or subroutines, carried out in the exemplary method. Additionally, the illustrated order of blocks is by example only and the order of the blocks can change according to the present disclosure. The exemplary method can begin at block 101.

At block 101, the receiving unit 21 is provided to receive a light signal having a predetermined flashing frequency emitted by a light source 11 located at a predetermined position.

At block 102, the light signal is analyzed to obtain the predetermined flashing frequency.

At block 103, the predetermined position is obtained according to the predetermined flashing frequency.

It will be understood that the above particular embodiments are shown and described by way of illustration only. The principles and the features of the present disclosure can be employed in various and numerous embodiments thereof without departing from the scope of the disclosure. The above-described embodiments illustrate the scope of the disclosure but do not restrict the scope of the disclosure.

What is claimed is:

1. A light indicating device comprising:
a plurality of light sources located in at least two positions; and
at least one driving unit configured for driving the light sources to flash, wherein light sources at a same position flash at a same frequency, and light sources at different positions flash at different frequencies.

2. The light indicating device of claim 1, wherein the light sources are light emitting diodes.

3. The light indicating device of claim 1, wherein all the light sources flash at frequencies above 60 Hz.

4. A positioning device comprising:
a receiving unit configured for receiving a light signal emitted by a current light source belonging to a plurality of light sources; and
a navigation unit configured for storing positions of the light sources, flashing frequencies of the light sources and relationships between positions and flashing frequencies, analyzing the light signal to obtain the flashing frequency of the current light source, comparing the flashing frequency of the current light source with the flashing frequencies stored in the navigation unit, and obtaining the position of the current light source.

5. The positioning device of claim 4, wherein the receiving unit converts the light signal into electrical signal and sends the electrical signal to the navigation unit.

6. The positioning device of claim 4, wherein the receiving unit is at least one selected from the group comprising camera and photoelectric sensing module.

7. The positioning device of claim 4, wherein the navigation unit comprises a display for displaying a map and the position of the current light source in the map.

8. A positioning method, comprising:
receiving a light signal emitted by a current light source belonging to a plurality of light sources located at least two positions, wherein light sources at a same position flash at a same frequency, and light sources at different positions flash at different frequencies;
analyzing the light signal to obtain the flashing frequency of the light signal; and
comparing the flashing frequency of the light signal with stored information to obtain the position of the current light source.

9. The positioning method of claim 8, wherein in the step of analyzing the light signal to obtain the flashing frequency of the light signal, when receiving at least two light signals at a same time, only analyzing the strongest light signal.

10. The positioning method of claim 8, wherein the stored information comprising positions of the light sources, flashing frequencies of the light sources and relationships between positions and flashing frequencies.
